(19) United States
(12) Patent Application Publication
(10) Pub. No.: US 2006/0150235 A1
(43) Pub. Date: Jul. 6, 2006

(54) Display system and method

(75) Inventors: Kuan-Hong Hsieh, Tu-Cheng (TW); Xiao-Guang Li, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry Co., LTD., Tu-Cheng City (TW)

(21) Appl. No.: 11/266,043

(22) Filed: Nov. 3, 2005

(30) Foreign Application Priority Data
Dec. 30, 2004 (CN) 200410091948.9

(51) Int. Cl. H04N 7/173; H04N 5/44; H04N 7/16

(52) U.S. Cl. 725/135; 348/725; 725/131

(57) ABSTRACT

A display method includes the steps of: providing a computer and at least one display terminal; extracting real-time playing pictures and corresponding sounds in the computer; compressing and encrypting the pictures and the sounds; transmitting the compressed pictures and sounds to the display terminal via a network; detecting whether network signals including picture signals and sound signals are being transmitted to a network port of the display terminal; receiving the network signals if there are picture signals and sound signals being transmitted to the network port; determining whether an identification (ID) of the pictures and sounds matches an ID of the display terminal; decompressing the received pictures and sounds if the identification (ID) of the pictures and sounds matches the ID of the display terminal; and playing the pictures and accompanying sounds. A related system is also disclosed.

### BACKGROUND OF THE INVENTION

1. Field of the Invention

The present invention relates generally to electronic systems and methods that communicate information for display, and particularly to a display system and method for display of real-time pictures.

2. General Background

Conventionally, when a user needs to use a computer, he/she must operate an interface of the computer located at the computer itself. If the user moves to another location, he/she cannot use the computer. With the development of Personal Computers (PCs), electronic devices, and the Internet, PCs can now communicate with other electronic devices through the Internet. In addition, the development of wireless communication enhances convenient use of electronic products. Coupled with wireless communication technology, peripheral electronic devices expand the scope of operation of a computer from on-site operation to mobile operation. That is, users may change from one location to another without having to move the computer. Hence devices such as wireless displays have been developed to work with wireless computer systems.

However, wireless communication is subject to interference by radio waves from other sources, which can result in low quality communication. The transmission speed of the wireless communication is low, so it cannot meet the transmissions of the PC images and sounds or TV program, which is prone to result in discontinuously playing images and sounds. In addition, the cost of building and operating wireless communication infrastructure can be exceedingly high.

What is needed is a display system and method which can overcome the above-described problems, in order to provide convenient, reliable, high quality displays at a moderate cost.

### SUMMARY

A display system in accordance with a preferred embodiment includes a computer and at least one display terminal. The computer is connected with the display terminal through a network. The computer includes a picture extracting unit for extracting real-time pictures; a sound extracting unit for extracting sounds corresponding to the pictures; a compressing unit for compressing the pictures and the sounds; a network interface unit for transmitting the compressed pictures and sounds to the display terminal; and the display terminal includes a Microprogrammed Control Unit (MCU) and a playing unit, a network port for connecting to a network; a network data processing unit for detecting whether there are network signals including the picture signals and sound signals being transmitted to the network port, and receiving the pictures and sounds if there are the network signal transmitted to the network port; and a decompressing unit for decompressing the compressed pictures and sounds.

A portable display terminal in accordance with a preferred embodiment includes a network port for connecting to a network; a data processing unit for detecting whether there are network signals including picture signals and sound signals being transmitted to the network port, and receiving the pictures and sounds if there are the network signals being transmitted to the network port; a decompressing unit for decompressing the compressed pictures and sounds; a Microprogrammed Control Unit (MCU) for controlling the decompressing unit to perform function; and a playing unit for playing the pictures and accompanying sounds.

A display method is also provided. The method includes the steps of: (a) extracting pictures and corresponding sounds in the computer; (b) compressing the pictures and the sounds; (c) transmitting the compressed pictures and sounds to the display terminal via a network; (d) detecting whether network signals including picture signals and sound signals are being transmitted to a network port of the display terminal; (e) receiving the network signals if there are picture signals and sound signals being transmitted to the network port; (f) decompressing the compressed pictures and sounds; and (g) playing the pictures and accompanying sounds.

Other advantages and novel features will be drawn from the following detailed description of preferred and exemplary embodiments with reference to the attached drawings, in which:

### BRIEF DESCRIPTION OF THE DRAWINGS

FIG. 1 is a block diagram of hardware infrastructure of a display system in accordance with a preferred embodiment of the present invention;

FIG. 2 is a flowchart of a preferred method for controlling remote display of real-time pictures and sounds, by using a computer of the system of FIG. 1; and

FIG. 3 is a flowchart of a preferred method for controlling remote display of real-time pictures and sounds, by using a display of the system of FIG. 1.

### DETAILED DESCRIPTION OF THE EMBODIMENTS

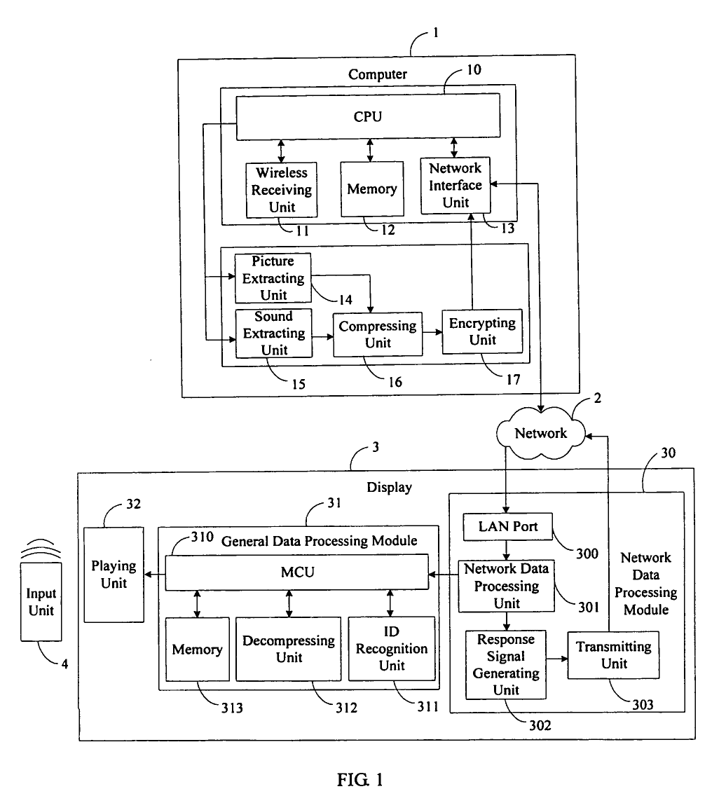

Referring now to the drawings, FIG. 1 is a block diagram of hardware infrastructure of a display system (hereafter, “the system”) in accordance with the preferred embodiment of the present invention. The system includes a computer 1, at least one display 3, and an input unit 4. Real-time pictures and accompanying sounds are sourced in the computer 1. Where there is more than one display 3, the system can provide playing of the real-time pictures and accompanying sounds on the plurality of displays 3 simultaneously. However, in order to describe the preferred embodiment in simple terms, only one display 3 is shown in FIG. 1 and described hereinafter. The computer 1 is connected with the display 3 through a network 2. The network 2 may be any suitable communication architecture required by the system, such as a Wide Area Network (WAN), a Local Area Network (LAN), and so on. The display 3 possesses a unique ID as a decryption key. The input unit 4 is for receiving a user operation, generating a corresponding control signal, and transmitting the control signal to the computer 1 by wireless means, in order to control the computer 1.

The computer 1 includes a hardware portion and a software portion. The hardware portion includes a Central Processing Unit (CPU) 10, a wireless receiving unit 11, a memory 12, and a network interface unit 13. The CPU 10 is connected with the wireless receiving unit 11, the memory 12, and the network interface unit 13. The wireless receiving unit 11 is for receiving control signals from the input unit 4. The memory 12 is providing for storing pictures and corresponding sounds. The network interface unit 13 is provided for packaging encrypted pictures and sounds from the software portion, and transmitting corresponding packages to the display 3 through the network 2. The software portion includes a picture extracting unit 14, a sound extracting unit 15, a compressing unit 16, and an encrypting unit 17. The picture extracting unit 14 extracts real-time pictures, and transmits the pictures to the compressing unit 16. The sound extracting unit 15 extracts sounds corresponding to the pictures, and transmits the sounds to the compressing unit 16. The compressing unit 16 compresses the pictures and sounds according to the Moving Picture Experts Group (MPEG) standard. The encrypting unit 17 encrypts the compressed pictures and sounds according to an assigned identification (ID), in order that the display 3 with a matching ID can play the pictures and sounds.

The display 3 includes a network data processing module 30, a general data processing module 31, and a playing unit 32. The network data processing module 30 includes a LAN port 300, a network data processing unit 301, a response signal generating unit 302, and a transmitting unit 303. The network data processing unit 301 is used for detecting whether there are LAN signals including picture signals and sound signals being transmitted to the LAN port 300. If there are picture signals and sound signals, the network data processing unit 301 receives the LAN signals. The general data processing module 31 includes a Microprogrammed Control Unit (MCU) 310, an ID recognition unit 311, a decompressing unit 312, and a memory 313. The MCU 310 controls the ID recognition unit 311 and the decompressing unit 312 to perform respective functions, as described below. The ID recognition unit 311 is provided for determining whether the ID of the compressed pictures and sounds matches the ID of the display 3. If the ID of the compressed pictures and sounds matches the ID of the display 3, the response signal generating unit 302 generates a response signal. The response signal is sent to the computer 1 via the transmitting unit 303 and the network 2, so as to notify the computer 1 to continue to transmit the encrypted pictures and sounds. The decompressing unit 312 decompresses the compressed pictures and sounds, the memory 313 stores the pictures and sounds, and the playing unit 32 plays the pictures and accompanying sounds. If the ID of the compressed pictures and sounds does not match the ID of the display 3, the playing unit 32 displays prompt information to indicate that there are no pictures and corresponding sounds being played on the display 3.

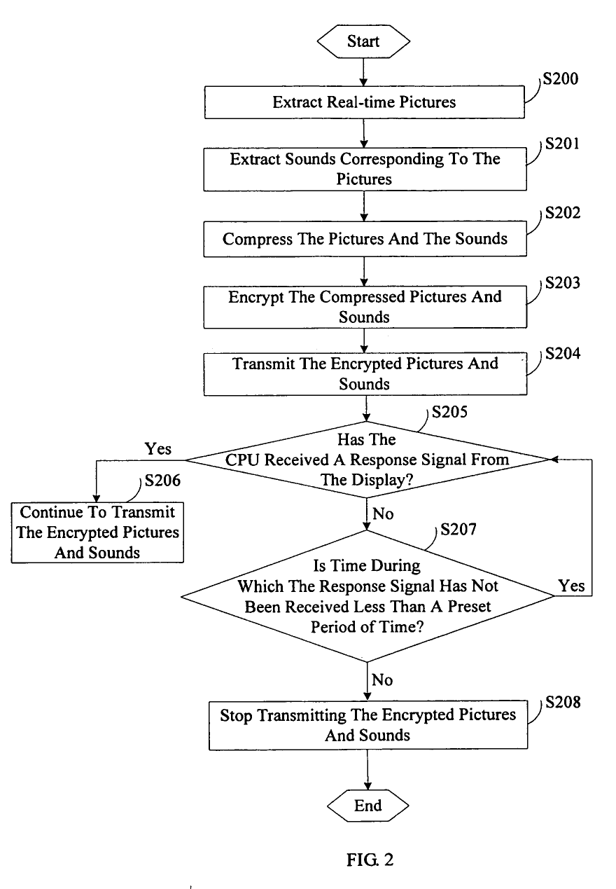

FIG. 2 is a flowchart of a preferred method for controlling remote display of real-time pictures and sounds, by using the computer 1 of the system. In step S200, the picture extracting unit 14 extracts real-time pictures, and transmits the pictures to the compressing unit 16. In step S201, the sound extracting unit 15 extracts sounds corresponding to the pictures, and transmits the sounds to the compressing unit 16. In step S202, the compressing unit 16 compresses the pictures and sounds according to the MPEG standard. In step S203, the encrypting unit 17 encrypts the compressed pictures and sounds according to an assigned ID, and transmits the encrypted pictures and sounds to the network interface unit 13. In step S204, the network interface unit 13 transmits the encrypted pictures and sounds to the LAN port 300. In step S205, the CPU 10 determines whether the network interface unit 13 has received a response signal from the display 3. If the network interface unit 13 has received the response signal (that is, the ID of the compressed pictures and sounds matches the ID of the display 3), in step S206, the network interface unit 13 continues to transmit the encrypted pictures and sounds. In contrast, if the network interface unit 13 has not received the response signal (that is, the ID of the compressed pictures and sounds does not match the ID of the display 3), in step S207, the CPU 10 determines whether an elapsed time during which the response signal has not been received is less than a preset period of time. If the elapsed time is less than the preset period of time, the procedure returns to step S205 described above. Otherwise, if the elapsed time is equal to or more than the preset period of time, in step S208, the network interface unit 13 stops transmitting the encrypted pictures and sounds, whereupon the procedure is ended.

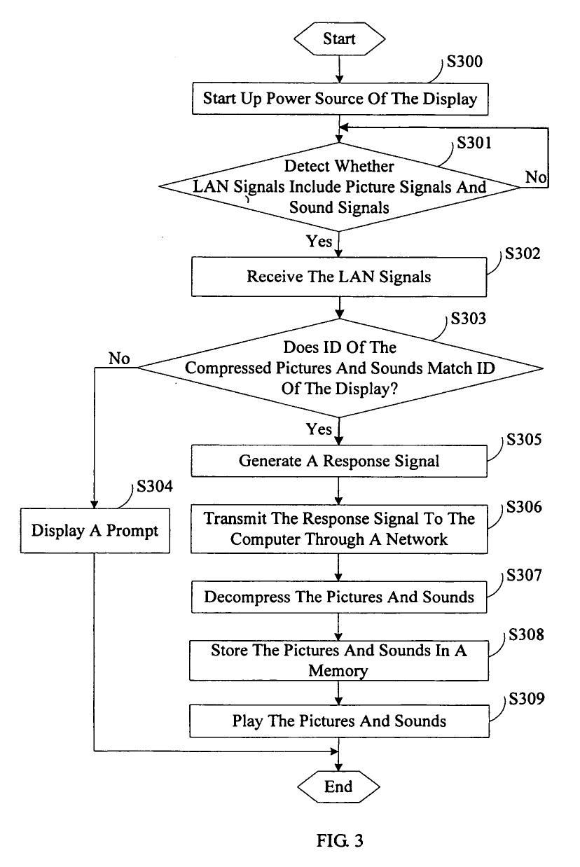

FIG. 3 is a flowchart of a preferred method for controlling remote display of real-time pictures and sounds, by using the display 3 of the above-described system. In step S300, the display 3 is powered on. In step S301, the network data processing unit 301 detects whether there are LAN signals including encrypted picture signals and corresponding sound signals being transmitted to the LAN port 300. If there are no picture signals and sound signals being transmitted to the LAN port 300, the network data processing unit 301 continues to detect whether there are the LAN signals being transmitted to the LAN port 300. If there are picture signals and sound signals being transmitted to the LAN port 300, in step S302, the network data processing unit 301 receives the LAN signals. In step S303, the ID recognition unit 311 determines whether the ID of the encrypted pictures and sounds matches the ID of the display 3. If the ID of the pictures and sounds does not match the ID of display 3, in step S304, the playing unit 32 displays prompt information to indicate that there are no pictures and sounds being played on the display 3, whereupon the procedure is ended. If the ID of the pictures and sounds matches the ID of the display 3, in step S305, the response signal generating unit 302 generates a response signal. In step S306, the transmitting unit 303 sends the response signal to the computer 1. In step S307, the decompressing unit 312 decompresses the compressed pictures and sounds. In step S308, the MCU 310 stores the pictures and sounds in the memory 313. In step S309, the playing unit 32 plays the pictures and accompanying sounds.

Although the present invention has been specifically described on the basis of a preferred embodiment and preferred method, the invention is not to be construed as being limited thereto. Various changes or modifications may be made to the embodiment and method without departing from the scope and spirit of the invention.

We claim:

1. A display system, comprising a computer, at least one display terminal, and a decompressing unit, wherein:
the computer comprises:
a picture extracting unit for extracting real-time pictures;
a sound extracting unit for extracting sounds corresponding to the pictures;
a compressing unit for compressing the pictures and the sounds; and
a network interface unit for transmitting the compressed pictures and sounds to the display terminal;
the display terminal comprises:
a network port for connecting to a network; and
a network data processing unit for detecting whether there are network signals comprising picture signals and sound signals being transmitted to the network port, and receiving the compressed pictures and sounds if there are the network signals being transmitted to the network port; and
the decompressing unit is for decompressing the compressed pictures and sounds.

2. The system described in claim 1, further comprising an inputting unit for receiving a user operation, generating a corresponding control signal, and transmitting the control signal to the computer by wireless means in order to control the computer.

3. The system described in claim 2, wherein the computer further comprises a wireless receiving unit for receiving the control signal from the inputting unit.

4. The system described in claim 1, wherein the display terminal is assigned an identification (ID) for the purpose of receiving the compressed pictures and sounds.

5. The system described in claim 4, wherein the computer further comprises an encrypting unit for encrypting the compressed pictures and sounds according to the ID.

6. The system described in claim 5, wherein the display terminal further comprises an ID recognition unit for determining whether the ID of the compressed pictures and sounds matches the ID of the display terminal.

7. The system described in claim 6, wherein the display terminal further comprises a response signal generating unit for generating a response signal to be sent to the computer via the network so as to notify the computer to continue to transmit the encrypted pictures and sounds, if the ID of the compressed pictures and sounds matches the ID of the display terminal.

8. A portable display terminal, comprising:
a network port for connecting to a network;
a network data processing unit for detecting whether there are network signals comprising picture signals and sound signals being transmitted to the network port, and receiving the network signals if there are picture signals and sound signals being transmitted to the network port;
a decompressing unit for decompressing corresponding compressed pictures and sounds;
a Microprogrammed Controlling Unit (MCU) for controlling the decompressing unit to perform decompression; and
a playing unit for playing the decompressed pictures and accompanying sounds.

9. The portable display terminal described in claim 8, further comprising a memory for storing the decompressed pictures and sounds.

10. The portable display terminal described in claim 8, wherein the portable display terminal is assigned an identification (ID) for the purpose of receiving the compressed pictures and sounds.

11. The portable display terminal described in claim 10, further comprising an ID recognition unit for determining whether an ID of the pictures and sounds matches the ID of the portable display terminal.

12. The portable display terminal described in claim 11, further comprising a response signal generating unit for generating a response signal to be sent to a computer via a network, so as to notify the computer to continue to transmit the compressed pictures and sounds, if the ID of the pictures and sounds matches the ID of the portable display terminal.

13. A display method, comprising the steps of:
providing a computer and at least one display terminal;
extracting real-time playing pictures and corresponding sounds in the computer;
compressing the pictures and the sounds;
transmitting the compressed pictures and sounds to the display terminal via a network;
detecting whether network signals including picture signals and sound signals are being transmitted to a network port of the display terminal; and
receiving the network signals, if there are picture signals and sound signals being transmitted to the network port;
decompressing the compressed pictures and sounds; and
playing the pictures and accompanying sounds.

14. The method described in claim 13, wherein the display terminal is assigned an identification (ID) for the purpose of receiving the compressed pictures and sounds.

15. The method described in claim 14, further comprising the step of encrypting the compressed pictures and sounds via the computer according to the ID.

16. The method described in claim 15, further comprising the steps of determining whether the ID of the pictures and sounds matches the ID of the display terminal, and decompressing the compressed pictures and sounds if the ID of the pictures and sounds matches the ID of the display terminal.

17. The method described in claim 16, further comprising the step of displaying prompt information indicating that there are no pictures and sounds being played, if the ID of the pictures and sounds does not match the ID of the display terminal.

18. The method described in claim 16, further comprising the steps of generating a response signal and transmitting the response signal to the computer, if the ID of the pictures and sounds matches the ID of the display terminal.

19. The method described in claim 18, further comprising the step of determining whether the computer receives the response signal during a preset time period.

20. The method described in claim 19, further comprising a selective step of continuing to transmit the compressed pictures and sounds if the computer receives the response signal during the preset time period, and stopping transmitting of the compressed pictures and sounds if the computer does not receive the response signal during the preset time period.
